(19) United States
(12) Patent Application Publication
(10) Pub. No.: US 2016/0245641 A1
(43) Pub. Date: Aug. 25, 2016

(54) PROJECTION TRANSFORMATIONS FOR DEPTH ESTIMATION

(71) Applicant: Microsoft Technology Licensing, LLC, Redmond, WA (US)

(72) Inventors: Adarsh Prakash Murthy Kowdle, Redmond, WA (US); Adam Garnet Kirk, Seattle, WA (US); Cristian Canton Ferrer, Sammamish, WA (US); Oliver Whyte, Cambridge, MA (US); Sing Bing Kang, Redmond, WA (US)

(21) Appl. No.: 14/626,018

(22) Filed: Feb. 19, 2015

(51) Int. Cl. G01B 11/02; G06T 7/00

(52) U.S. Cl. CPC G01B 11/026; G06T 7/0075; G06T 2207/10048

(57) ABSTRACT

An active rangefinder system disclosed herein parameterizes a set of transformations predicting different possible appearances of a projection feature projected into a three-dimensional scene. A matching module matches an image of the projected projection feature with one of the transformations, and a depth estimation module estimates a distance to an object reflecting the projection feature based on the transformation identified by the matching module.

### BACKGROUND

Structured light patterns are used in some active depth sensing technologies to extract geometry from a scene. For example, a structured light pattern may be projected onto a scene, and observed deformations of the light pattern can be used to generate a depth map of a surrounding environment. In these types of active depth sensing technologies, depth map resolution may be limited by the density and resolution of individual projected light features (e.g., dots or other patterns).

### SUMMARY

Implementations described herein parameterize a set of transformations predicting an appearance of a projection feature projected into a three-dimensional scene. A reference image of the projected projection feature is matched with one of the parameterized transformations to estimate a distance to between the projected projection feature and a projection source.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example multimedia environment including a multimedia system configured to generate a depth map of a three-dimensional scene.

FIG. 2 illustrates aspects of a multimedia system that parameterizes a set of transformations to predict an appearance of projected light features in a three-dimensional scene.

FIG. 3 illustrates active rangefinder techniques of a multimedia system for generating a depth map of a surrounding environment.

FIG. 4 illustrates example operations for computing a depth map of a three dimensional scene.

FIG. 5 illustrates an example system that may be useful in implementing the described technology

### DETAILED DESCRIPTION

When reflected off objects in a scene, projected light features can be distorted by a variety of dispersion effects including, for example, surface reflectivity, object orientation, projection and an imaging device (e.g., a camera) defocus blur, noise, temporal flicker, motion blur, etc. When these distortions are not adequately accounted for, depth sensing resolution is diminished. According to one implementation of the disclosed technology, an active rangefinder system generates a high resolution depth map by comparing an image of a projected structured light pattern with a set of predictive transformations applied to a reference image of the structured light pattern.

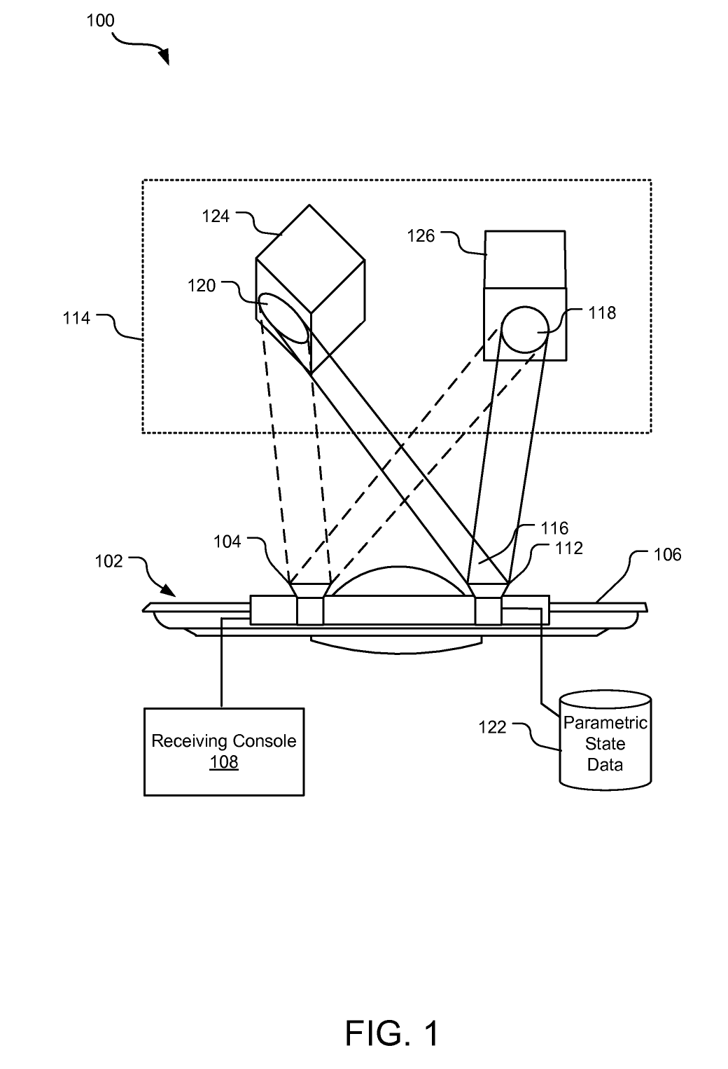

FIG. 1 illustrates an example multimedia environment 100 including a multimedia system 102 configured to generate a depth map of a three-dimensional scene 114. The multimedia system 102 may be without limitation a gaming system, a home security system, a computer system, a set-top box, a mobile device such as a tablet or smartphone, or any other device configured to generate a depth map of a surrounding environment. The multimedia system 102 may be used in a variety of applications including without limitation gaming applications, security applications, military applications, etc. A user 104 can interact with the multimedia system 102 by virtue of a user interface 106 and/or a transformation console 108. The user interface 106 may include a graphical display, an audio system, etc., while the transformation console 108 includes circuitry and/or software for transforming signals, reflected from within the three-dimensional scene and received by one or more imaging devices, into a depth estimation including a distance between the multimedia system 102 and an object in the surrounding environment. The transformation console 108 may include without limitation a gaming system, a blu-ray player, a set-top box, or other device capable of receiving electronic signals (e.g., radio frequency signals, infrared signals, etc.) transmitted from another electronic device (e.g., a remote, handheld controller, etc.) within the three-dimensional scene 114 and estimating the distance to the object in the surrounding environment based on projection transformations.

The multimedia system 102 is configured to capture and monitor light from within a field of view of one or more imaging devices communicatively connected to the multimedia system 102. Among other components, the multimedia system 102 includes a pattern projector 112 that projects a signal such as visible light (e.g., RGB light) or invisible light (e.g., IR light) into a field of view (e.g., the three-dimensional scene 114). The projected light is reflected off objects within the three-dimensional scene 114 (e.g., objects 124 and 126), detected by the imaging device 104, and used to generate a depth map quantifying distances to the objects.

Although a variety of suitable imaging devices are contemplated, the imaging device 104 is, in one implementation, an infrared camera that detects reflected infrared light that is projected into the three-dimensional scene 114 by a pattern projector 112. The imaging device 104 may be used alone or in combination with other cameras and sensors that supplement active rangefinder operations, such as technologies useful in object and motion detection. For example, other implementations of the multimedia system 102 may include electrical sensors, stereoscopic sensors, scanned laser sensors, ultrasound sensors, millimeter wave sensors, etc. Some implementations utilize stereo imaging techniques and corroborate data collected by two or more cameras at different positions to generate a depth map.

In one implementation, the pattern projector 112 projects a structured (e.g., known or predetermined) light pattern 116 onto the three-dimensional scene 114. The structured light pattern 116 is of a wavelength detectable by the imaging device 104 and may include any number of different projection features (e.g., projection features 118, 120) recognizable via analysis of data captured by the imaging device 104. In FIG. 1, the structured light pattern 116 is a speckle (e.g., dot) pattern. In other implementations, the structured light pattern 116 includes projection features of a variety of shapes, sizes, and forms.

The imaging device 104 captures an image of the projected structured light pattern and various modules of the multimedia system 100 analyze the captured image to infer information about one or more objects present in the three-dimensional scene 114. For example, the apparent size or sharpness of the projection features 118 and 120 may provide information about a distance to the objects 124 and 126; an apparent brightness of the projection features 118 and 120 may provide information about the reflectance of the objects 124 and 126; shapes of the projection features 118 and 120 may provide information about surface angles of the objects 124 and 126 relative to the imaging device 104, etc.

In one implementation, the multimedia system 100 compares a captured image of the structured light pattern 116 to a set of reference images transformed by parametric state data stored in a memory device 122. The transformed reference images each predict an appearance of the structured light pattern 116 when projected onto the three-dimensional scene 114. For example, a number of copies of a single reference image including the projection feature 120 may each be subjected to a different transformation parameterizing one or more different dispersion effects potentially observable in an image of the structured light pattern 116 projected into the three-dimensional scene 114. For instance, a transformation may be a parameterized change from one state to another to account for dispersion due to one or more of surface reflectivity, object orientation, defocus blur, noise, temporal flicker, motion blur, etc.

The transformed versions of the reference image can be compared to a raw image of the structured light pattern captured by the imaging device 104 to determine a transformation that relatively closely mimics observed distortions of the projection feature 120. The transformation that relatively closely mimics the observed distortions may more closely mimic the observed distortions than other transformations. Based on this information, the multimedia system 100 can estimate a distance between the imaging device 104 and the object 124 on which the projection feature 120 is reflected. Estimating a distance may, in some implementations, yield a range of values including the actual distance between the imaging device 104 and the object 124.

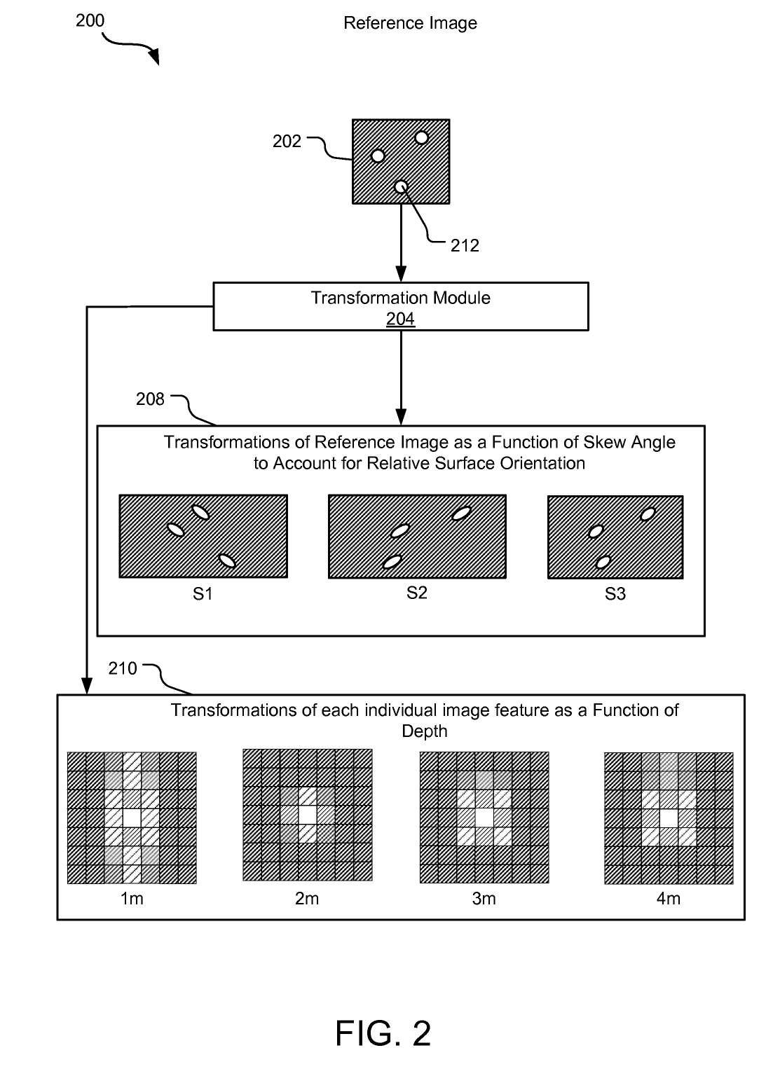

FIG. 2 illustrates transformations of a reference image 202 by a multimedia system 200 to predict an appearance of certain projection features imaged on objects in a three-dimensional imaging space. The multimedia system 200 includes a transformation module 204 that creates a reference data array for comparison to raw image data of the projection features captured by a sensing device (not shown). The transformation module 204 generates the reference data array by parameterizing a set of transformations and applying those transformations to the reference image 202.

When applied to the reference image 202, the parameterized transformations mimic various distortions of the projection features potentially observable in raw image data, such as distortions attributable to surface reflectivity, skew orientation of one or more objects, motion blur due to movement of the object(s), image noise, camera or projector defocus blur, etc.

In FIG. 2, the multimedia system 200 generates a reference data array including exemplary image sets 208 and 210, which introduce transformative effects mimicking dispersions potentially observable in raw data. Specifically, each image in the transformed image set 208 introduces a different two-dimensional skew to the reference image 202, mimicking dispersion attributable to relative surface orientations of various object orientations in the three-dimensional imaging space.

Images in the transformed image set 210 sample random disparities modeling an appearance of an individual projection feature 212 reflected on objects of varying distance from an imaging device. In particular, the images in the transformed image set 210 each depict a 7×7 pixel square including pixel luminosity variations observable at depths of 1, 2, 3, and 4 meters, respectively, from an imaging device. These exemplary effects introduced by the transformative module 204 may vary significantly in different multimedia systems depending on a variety of system parameters including, for example, projector focal length, system magnification, light source intensity, etc.

In FIG. 2, each of the image sets 208 and 210 introduces variations on a single transformative effects (skew or distance); however, it should be understood that the transformation module 204 may apply a combination of transformative effects to individual images. For example, each image output by the transformation module 204 may introduce a random disparity (e.g., modeling distance of 1 m, 2 m, 3 m, or 4 m), one of multiple different skew angles, and one or more other transformative effects.

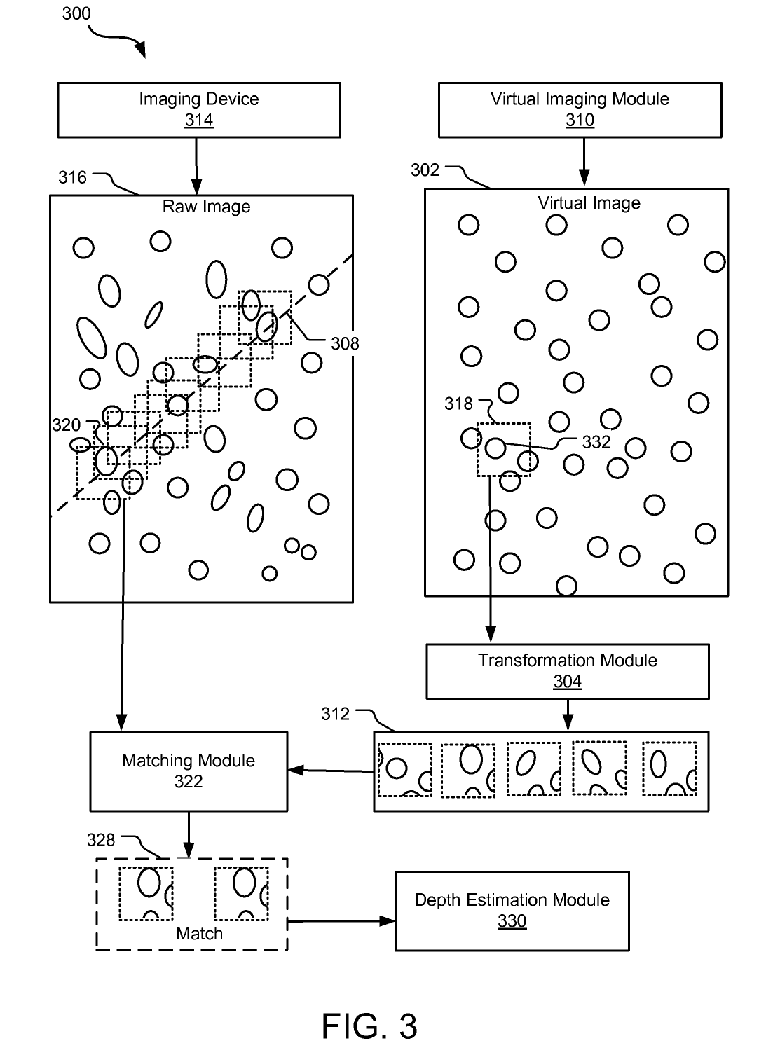

FIG. 3 illustrates active rangefinder techniques of a multimedia system 300 for generating a depth map of a surrounding environment. The multimedia system 300 includes a pattern projector (not shown) that projects a structured light pattern into a three-dimensional scene. The structured light pattern includes a number of projection features (e.g., a projection feature 332) which may be of variable or uniform size and/or shape.

An imaging device 314 captures a raw image 316 of the projected structured light pattern for comparison to a virtual image 302 (e.g., an adjusted or modified reference image). The raw image 316 is an image of the structured light pattern projected into a three-dimensional scene (e.g., an image of the structured light pattern reflected off various objects in a room).

The virtual image 302 is an image created based on a reference image, which may be, for example, a digitally-created image of the structured light pattern or a raw image of the structured light pattern projected onto one or more known objects. For example, the reference image may be an image of the structured light pattern projected onto a two-dimensional screen positioned at a known distance from the pattern projector. During generation of the virtual image 302, the imaging module 310 identifies a number of “peak” positions within the reference image. For example, the peak positions identified by the virtual imaging module 310 may each represent an approximate center of a projection feature, a pixel exceeding a threshold brightness, etc. The virtual imaging module 310 shifts a position of each of the identified peak positions in the reference image to account for a physical separation between the imaging device 314 and a pattern projector of the multimedia system 300. For example, the virtual imaging module 310 may shift each of the identified peak positions with sub-pixel precision to a resulting position corresponding to a location of the peak position in the raw image 316.

The virtual imaging module 310 may also apply luminosity alterations to the reference image. In one implementation, the virtual image 302 is created by applying a Gaussian luminosity distribution at each of the identified peak positions of the reference image. For example, the virtual imaging module 310 may start with a blank image and drop a truncated Gaussian luminosity distribution of empirically-obtained size and variance at each of the identified peak locations.

The virtual image 302 is output from the virtual image module 310 and input to a transformation module 304. The transformation module 304 defines a number of “patches” within the virtual image 302, such as a patch 318. For each of the defined patches, the virtual imaging module 310 identifies an associated epipolar line 308 along which the defined patch of the virtual image 302 is constrained to appear in the raw image 316. Based on projective geometry, the epipolar line 308 represents a line of projection for a projection device as observed from the point of view of the imaging device 314, and therefore, the points of the virtual image 302 lie on the epipolar line 308, according to the principle of epipolar constraint within projective geometry. As such, the epipolar line 308 is computed based on the parameters of the imaging device 314 and of the pattern projector (not shown). Due to projector geometry, the projection feature 332 may, for example, appear closer to the lower left end of the epipolar line 308 in the raw image 316 when reflected off a near-field object and nearer to the upper right end of the epipolar line 308 when reflected off a far-field object.

Each defined patch (e.g., the patch 318) of the virtual image 302 includes one or more projection features. In one implementation, each of the patches has a center pixel at one of the defined peak positions. A same pixel or subset of pixels may be included in multiple different “overlapping” patches.

The transformation module 304 transforms each of the defined patches of the virtual image 302 according to a set of parameterized transformations that each predict a possible appearance of a corresponding patch (e.g., a patch 320) in the raw image 316. Each applied transformation parameterizes one or more combined dispersion effects such as effects attributable to skew, scale alteration, projector defocus, blur, camera defocus blur, noise, temporal flicker, motion blur, etc.

In one implementation, a transformation is applied to every pixel in the patch 318. For example, transformation equation (1) (below) applies a random disparity ‘d.’ to each pixel of the patch 318 and thereby parameterizes a dispersion effect mimicking a distance change between a pattern projector and an object where light is reflected. In transformation equation (1), ‘float 2 rightPos’ represents a transformed coordinate set including two float values (rightPos.x and rightPos.y); ‘pos’ is an original pixel location in the virtual image 316 represented as two floats (pos.x and pos.y); and “offset” is a two-dimensional pixel shift along the epipolar line 308 of predefined magnitude.

float2 rightPos=float2(pos.x−disparity_sign*d,pos.y)+offset (1)

Another example transformation represented by transformation equation (2) (below) applies a random skew to the output of transformation equation (1), thereby modeling both a random disparity and a random skew. In equation (2), the variable ‘s’ represents a random skew represented as a floating point number between −1 and 1.

IF_USE_SKEW_PATCHES(rightPos.x+=s*offset.y) (2)

The transformation module 304 provides transformed images 312 to a matching module 322, and the matching module 322 compares the set of transformed images to each of a number of patches (e.g., a patch 320) of the raw image 316 constrained to lie along the epipolar line 308 of the patch 318 of the virtual image 302. For example, the matching module 322 identifies a series of potential matches for the patch 318 by shifting coordinates of an equal-sized patch of the raw image 316 along the epipolar line 308 such that a pixel center of the equal-sized patch assumes a number of different positions along the epipolar line 308.

The matching module 322 compares each one of the transformed images 312 of the patch 318 to each one of the identified potential matches of raw image 316, thereby generating a number of image pairs and computing a match metric quantifying a similarity between images of each pair. Based on the computed match metrics, the matching module 322 identifies the most similar pair as a best match 328. The match metric may be, for example, any one of a number of suitable dataset statistical comparison tests, including without limitation a chi-square test, Shapiro-Wiki test, f-test, t-test, Kolmogorov-Smirnov, and the like.

The matching module 322 supplies the best match 328 to a depth estimation module 330 along with parametric state data used to generate the image transformation associated with the best match 328. With these inputs, the depth estimation module 330 estimates a distance between the imaging device 314 and object(s) in the three-dimensional scene reflecting projection features included in the patch 318.

For example, inputs to the depth estimation module 330 may include information sufficiently identifying a patch in the virtual image 302 (e.g., the patch 318), a particular transformation applying one or more dispersion effects, and a corresponding patch (e.g., the patch 320) in the raw image 316. Using this information, the depth estimation module 330 determines a “depth value” to associate with one of the identified peak positions (e.g., pixel positions) included in the best match 328. The depth value represents a relative distance between the imaging device 314 and a point on an object in the three-dimensional scene reflecting light corresponding to a pixel at a peak position in the raw image 316. The estimated depth value is based on logic that accounts for one or a variety of dispersion effects modeled by the associated transformation. For example, an estimated depth value may account for skew of the projected image features, reflectance of various objects, projector and/or camera defocus blur, noise, temporal flicker, motion blur, etc.

The above-described method can be repeated for each patch in the virtual image 302 until depth values are associated with substantially all projection features in the raw image 316. In this manner, the depth estimation module 330 can infer a depth value at each of a number of identified peak positions (e.g., individual pixels) in the raw image 316. In one implementation, the depth estimation module 330 outputs a depth map quantifying depth of a three-dimensional scene onto which the multimedia system 300 projects the structured light pattern.

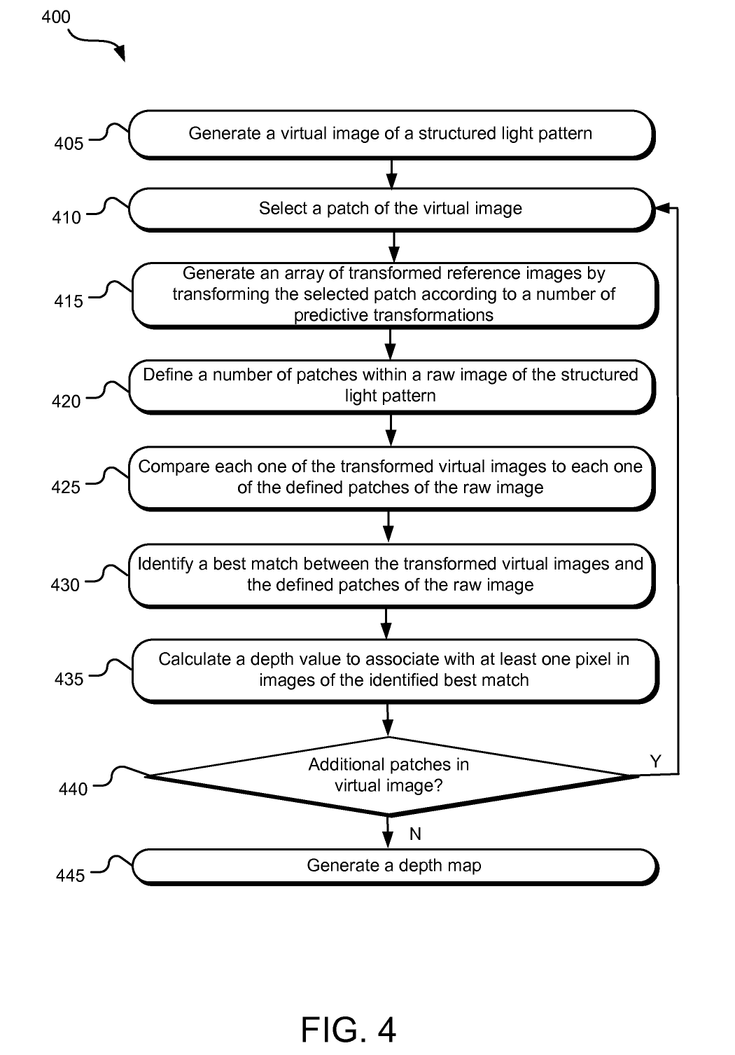

FIG. 4 illustrates example operations 400 for computing a depth map of a three dimensional scene. A virtual imaging operation 405 generates a virtual image (e.g., an adjusted reference image, such as that described above with respect to FIG. 3) of a structured light pattern by shifting the reference image to account for a physical separation between an imaging device and a pattern projector of a multimedia system that projects the structured light pattern into a three-dimensional scene.

In one implementation, the virtual image generation operation 405 identifies each of a number of “peak locations” in the reference image, such as pixel locations indicating respective centers of various projection features included in the structured light pattern. Pixel luminosity may be adjusted at and/or around each of the identified peak locations. The virtual imaging operation 405 further identifies an epipolar line along which a pixel corresponding to each peak location may appear to shift in a raw image of the structured light pattern when the structured light pattern is projected onto a scene and captured by an imaging device.

A selection operation 410 selects a reference “patch” of the virtual image for transformation and comparison to a raw image of the projected structured light pattern captured by the imaging device. In one implementation, the selection operation 410 selects a patch that is centered at one of the peak locations and includes at least one projection feature.

A transformation operation 415 transforms the selected patch of the virtual image according to a set of parameterized transformations predicting possible appearances of projection features of the selected patch as they may appear in the captured raw image. For example, the transformation operation 415 may transform the selected patch of the virtual image according to a variety of transformations that model variations of one or more dispersion effects such as effects attributable to skew, scale alteration, projector defocus, blur, camera defocus blur, noise, temporal flicker, motion blur, etc. Images resulting from the transformations of the virtual image are referred to hereinafter as a “transformed reference array.” In at least one implementation, each image in the transformed reference array introduces a different random disparity and/or two-dimensional skew to the reference image.

A region-of-interest identification operation 420 defines a number of patches in the raw image corresponding in size and shape to the patches in the transformed reference array. In one implementation, each of the defined patches of the raw image is constrained to have a center lying along a same epipolar line as a center of the selected patch of the virtual image. A comparison operation 425 compares each patch in the transformed reference array to each one of the defined patches of the raw image. For example, the comparison operation 425 may generate an array of comparison pairs, where each comparison pair includes one image from the transformed reference array and one of the defined patches of the raw image. The comparison operation 425 measures similarity between the images of each comparison pair.

Based on output from the comparison operation 425, an identification operation 430 identifies which of the comparison pairs is a best match (e.g., includes a most similar pair of images). The best match identifies a select one of the defined patches of the raw image(hereinafter the “best patch”) for a depth estimation operation 435.

The depth estimation operation 435 uses transformation information associated with the identified best match to calculate a depth value to associate with one or more projection features depicted in the images of the best match. The depth value indicates a relative distance between the imaging device and an object in an imaging space reflecting a projection feature of interest. In one implementation, the depth estimation operation 435 calculates a depth value to associate with any peak location(s) included in the best patch of the raw image, such as a center of the best patch and/or centers of each projection feature included in the best patch. In another implementation, the depth estimation operation 435 calculates a depth value for each pixel of the best patch.

A determination operation 440 determines whether there exist additional patches of the virtual image with projection features that have not yet been associated with depth values via the operations 415, 420, 425, 430 and 435. If additional patches remain, the operations 415, 420, 425, 430, and 435 are repeated until at least one depth value is associated with each projection feature in the virtual image. When all patches of the virtual image are associated with depth values, a generation operation 445 generates a depth map of each of the computed depth values.

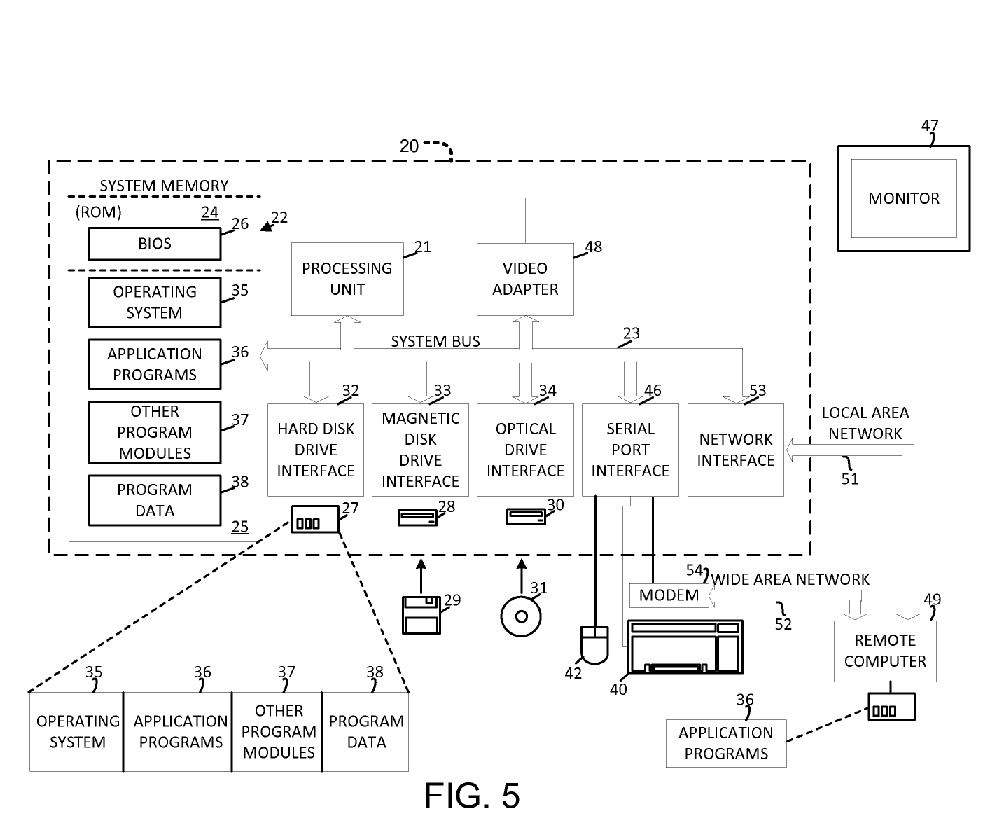

FIG. 5 illustrates an example system that may be useful in implementing the described technology. The example hardware and operating environment of FIG. 5 for implementing the described technology includes a computing device, such as general purpose computing device in the form of a gaming console, multimedia console, or computer 20, a mobile telephone, a personal data assistant (PDA), a set top box, or other type of computing device. In the implementation of FIG. 5, for example, the computer 20 includes a processing unit 21, a system memory 22, and a system bus 23 that operatively couples various system components including the system memory to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the invention is not so limited.

The system bus 23 may be any of several types of bus structures including a memory bus or memory controller, a peripheral bus, a switched fabric, point-to-point connections, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program engines and other data for the computer 20. It should be appreciated by those skilled in the art that any type of computer-readable media which can store data that is accessible by a computer, such as magnetic cassettes, flash memory cards, digital video disks, random access memories (RAMs), read only memories (ROMs), and the like, may be used in the example operating environment.

A number of program engines may be stored on the hard disk, magnetic disk 29, optical disk 31, ROM 24, or RAM 25, including an operating system 35, one or more application programs 36, other program engines 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the invention is not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 5. The logical connections depicted in FIG. 5 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program engines depicted relative to the personal computer 20, or portions thereof, may be stored in the remote memory storage device. It is appreciated that the network connections shown are example means of communications devices for establishing a communications link between the computers may be used.

In an example implementation, a virtual imaging module, transformation module, matching module, and depth estimation module are embodied by instructions stored in memory 22 and/or storage devices 29 or 31 and processed by the processing unit 21. Sensor or imaging device signals (e.g., visible or invisible light and sounds), depth information, and other data may be stored in memory 22 and/or storage devices 29 or 31 as persistent datastores.

The example hardware and operating environment of FIG. 5 may include a variety of tangible computer-readable storage media and intangible computer-readable communication signals. Tangible computer-readable storage can be embodied by any available physical media that can be accessed by the computer 20 or by other devices included in the hardware and operating system. Further, the term tangible computer-readable media and includes both volatile and nonvolatile storage media and removable and non-removable storage media. Tangible computer-readable storage media excludes intangible communications signals and includes volatile and nonvolatile, removable and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can accessed by the computer 20 or from within the hardware and operating environment of FIG. 5. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. An example system for estimating distance between a projector and a surface in a three-dimensional image space includes an imaging device that captures an image of a projection feature projected by the projector and reflected on the surface in the three-dimensional image space. An appearance transformer parameterizes a set of transformations. The transformations predict different possible appearances of the projection feature projected onto the surface. A projection matcher matches the captured image of the projected projection feature with a select one of the transformations. A depth estimator generates an estimation of the distance between the projector and the surface based on the select one of the transformations.

Another example system of any preceding system is disclosed wherein each transformation in the set of transformations introduces a different two-dimensional skew modeling an orientation variation of an imaging surface.

Another example system of any preceding system is disclosed wherein each transformation in the set of transformations introduces a random disparity modeling a depth variation of an imaging surface.

Another example system of any preceding system is disclosed wherein the appearance transformer applies the set of transformations to a patch of the reference image including the projection feature.

Another example system of any preceding system is disclosed wherein the prediction matcher compares the patch of the reference image to a number of patches of the captured image aligned along a same axis.

Another example system of any preceding system is disclosed wherein each transformation in the set of transformations models a different depth of an imaging surface relative to the projector.

Another example system of any preceding system is disclosed wherein the prediction matcher matches a pixel in the captured image with a pixel in a reference image. The reference image is transformed by one of the transformations of the appearance transformer.

An example method of estimating distance between a projector and a surface in a three-dimensional scene includes parameterizing a set of transformations predicting an appearance of a projection feature projected into the image space and projecting, with the projector, the projection feature into the image space. An image of the projected projection feature reflected on a surface in the image space is captured. The captured image of the projected projection feature is matched with a select one of the transformations. An estimation of distance between the projector and the surface is generated based on the select one of the transformations.

Another example method of any of the preceding methods is disclosed wherein each transformation in the set of transformations introduces a different two-dimensional skew modeling an orientation variation of an imaging surface.

Another example method of any of the preceding methods further includes applying the set of transformations to a reference image including the projection feature.

Another example method of any of the preceding methods is disclosed wherein each transformation in the set of transformations models a different depth of an imaging surface relative to the projector.

Another example method of any of the preceding methods is disclosed wherein matching the captured image with a select one of the transformations further includes matching a patch of the reference image to a number of patches of the captured image aligned along a same axis.

Another example method of any of the preceding methods is disclosed wherein matching the captured image of the projected projection feature with one of the transformations further includes matching a pixel in the captured image with a pixel in a reference image transformed by one of the transformations.

Another example method of any of the preceding methods is disclosed wherein each transformation in the set of transformations induces a two-dimensional skew angle to a patch in a reference image.

Another example method of any of the preceding methods further includes applying the set of transformations to each of a number of patches of a reference image. Each of the patches includes one or more different projection features. Different projection features are projected into the image space. An estimation of the distances to each of the different projection features is generated by comparing patches of the captured image to the transformed patches of the reference image.

In one or more computer-readable storage media encoding computer-executable instructions for executing a computer process that estimates distances between a projector and a plurality of projection features of a structured light pattern projected onto a three-dimensional scene, the computer process includes parameterizing a set of transformations for each of the projection features. The transformations each model an appearance of one of the projection features projected into the image space. A projector projects the structured light pattern into the image space. An imaging device captures an image of the projected structured light pattern. Each of the projection features in the captured image is matched with a select transformation from a different one of the parameterized sets of transformations. Estimations of the distances to the projection features are generated by determining, for each one of the projection features, an associated distance based on the select transformation matched to the projection feature.

The one or more computer-readable storage media of any preceding computer-readable storage media is disclosed wherein each transformation in the set of transformations induces a different two-dimensional skew modeling an orientation variation of an imaging surface.

The one or more computer-readable storage media of any preceding computer-readable storage media is disclosed wherein each transformation in the set of transformations introduces a random disparity modeling a depth variation of an imaging surface.

The one or more computer-readable storage media of any preceding computer-readable storage media is disclosed wherein matching the captured image with one of the transformations further includes applying the set of transformations to a reference image to generate a transformed reference array and comparing each image in the transformed reference array with a portion of the captured image of the structured light pattern.

The one or more computer-readable storage media of any preceding computer-readable storage media is disclosed wherein the computer process further includes wherein each transformation in the set of transformations models a different depth of an imaging surface relative to the projector.

An example system for estimating distance between a projector and a surface in a three-dimensional scene includes means for parameterizing a set of transformations predicting an appearance of a projection feature projected into the image space and means for projecting the projection feature into the image space. Means for capturing capture an image of the projected projection feature reflected on a surface in the image space. The captured image of the projected projection feature is matched by means for matching with a select one of the transformations. An estimation of the distance between the projector and the surface is generated by means for estimating based on the select one of the transformations.

Another example system of any of the preceding systems is disclosed wherein each transformation in the set of transformations introduces a different two-dimensional skew modeling an orientation variation of an imaging surface.

Another example system of any of the preceding systems further including means for applying the set of transformations to a reference image including the projection feature.

Another example system of any of the preceding systems is disclosed wherein each transformation in the set of transformations models a different depth of an imaging surface relative to the means for projecting.

Another example system of any of the preceding systems is disclosed wherein means for matching the captured image with a select one of the transformations further includes means for matching a patch of the reference image to a number of patches of the captured image aligned along a same axis.

Another example system of any of the preceding systems is disclosed wherein means for matching the captured image of the projected projection feature with one of the transformations further includes means for matching a pixel in the captured image with a pixel in a reference image transformed by one of the transformations.

Another example systems of any of the preceding systems is disclosed wherein each transformation in the set of transformations induces a two-dimensional skew angle to a patch in a reference image.

Another example system of any of the preceding systems further includes means for applying the set of transformations to each of a number of patches of a reference image. Each of the patches includes one or more different projection features. Different projection features are projected into the image space. An estimation of the distances to each of the different projection features is generated by comparing patches of the captured image to the transformed patches of the reference image.

Another example system for estimating distance between a projector and a surface in a three-dimensional image space includes one or more processors and an appearance transformer executed by the one or more processors that parameterizes a set of transformations. The transformations predict different possible appearances of a projection feature of an image projected onto a surface. A prediction matcher executed by the one or more processors matches the image of the projected projection feature with a select one of the transformations. A depth estimator executed by the one or more processors generates an estimation of distance between the projector of the image and the surface based on the select one of the transformations.

Another example system of any preceding system is disclosed wherein each transformation in the set of transformations introduces a different two-dimensional skew modeling an orientation variation of an imaging surface.

Another example system of any preceding system is disclosed wherein each transformation in the set of transformations introduces a random disparity modeling a depth variation of an imaging surface.

Another example system of any preceding system is disclosed wherein the appearance transformer applies the set of transformations to a patch of the reference image including the projection feature.

Another example system of any preceding system is disclosed wherein the prediction matcher compares the patch of the reference image to a number of patches of the image aligned along a same axis.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

The implementations of the embodiments described herein are implemented as logical steps in one or more computer systems. The logical operations of the disclosed embodiments are implemented (1) as a sequence of processor-implemented steps executing in one or more computer systems and (2) as interconnected machine or circuit modules within one or more computer systems. The implementation is a matter of choice, dependent on the performance requirements of the computer system implementing the disclosed embodiments. Accordingly, the logical operations making up the disclosed embodiments described herein are referred to variously as operations, steps, objects, or modules. Furthermore, it should be understood that logical operations may be performed in any order, adding and omitting as desired, unless explicitly claimed otherwise or a specific order is inherently necessitated by the claim language.

The above specification, examples, and data provide a complete description of the structure and use of exemplary embodiments. Since many alternative implementations of the disclosed embodiments can be made without departing from the spirit and scope of what is disclosed, the invention resides in the claims hereinafter appended. Furthermore, structural features of the different embodiments may be combined in yet another implementation without departing from the recited claims.

What is claimed is:

1. A system for estimating distance, the system comprising:
an imaging device to capture an image of a projection feature to be projected by a projector and reflected from a surface in a three-dimensional image space;
an appearance transformer to parameterize a set of transformations, the transformations predicting different possible appearances of the projection feature projected onto the surface;
a prediction matcher to match the captured image of the projected projection feature with a select one of the transformations; and
a depth estimator to generate an estimation of distance between a projector and a surface in a three-dimensional space based at least on the select one of the transformations.

2. The system of claim 1 wherein each transformation in the set of transformations introduces a different two-dimensional skew modeling an orientation variation of an imaging surface.

3. The system of claim 1 wherein each transformation in the set of transformations introduces a random disparity modeling a depth variation of an imaging surface.

4. The system of claim 1 wherein the appearance transformer applies the set of transformations to a patch of the reference image including the projection feature.

5. The system of claim 1 wherein the prediction matcher compares the patch of the reference image to a number of patches of the captured image aligned along a same axis.

6. The system of claim 1 wherein each transformation in the set of transformations models a different depth of an imaging surface relative to the projector.

7. The system of claim 1 wherein the prediction matcher matches a pixel in the captured image with a pixel in a reference image, the reference image transformed by one of the transformations of the appearance transformer.

8. A method of estimating distance, the method comprising:
parameterizing a set of transformations predicting an appearance of a projection feature projected into the image space;
projecting, with the projector, the projection feature into the image space;
capturing an image of the projected projection feature reflected on a surface in the image space;
matching the captured image of the projected projection feature with a select one of the set of transformations; and
generating an estimation of distance between a projector and a surface in a three-dimensional space based on the select one of the transformations.

9. The method of claim 8 wherein each transformation in the set of transformations introduces a different two-dimensional skew modeling an orientation variation of an imaging surface.

10. The method of claim 8 further comprising:
applying the set of transformations to a reference image including the projection feature.

11. The method of claim 10, wherein each transformation in the set of transformations models a different depth of an imaging surface relative to the projector.

12. The method of claim 8, wherein matching the captured image with a select one of the transformations further comprises:
matching a patch of the reference image to a number of patches of the captured image aligned along a same axis.

13. The method of claim 8, wherein matching the captured image of the projected projection feature with one of the transformations further includes:
matching a pixel in the captured image with a pixel in a reference image transformed by one of the transformations.

14. The method of claim 8, wherein each transformation in the set of transformations induces a two-dimensional skew angle to a patch in a reference image.

15. The method of claim 8, further comprising:
applying the set of transformations to each of a number of patches of a reference image, each of the patches including one or more different projection features;
projecting the different projection features into the image space; and
estimating a distance to each of the different projection features by comparing patches of the captured image to the transformed patches of the reference image.

16. A system for estimating distance, the system comprising:
one or more processors;
an appearance transformer to be executed by the one or more processors that parameterizes a set of transformations, the transformations predicting different possible appearances of the projection feature of an image projected onto a surface;
a prediction matcher to be executed by the one or more processors that matches the image of the projected projection feature with a select one of the transformations; and
a depth estimator to be executed by the one or more processors that generates an estimation of distance between a projector of the image and a surface in a three-dimensional space based on the select one of the transformations.

17. The system of claim 16 wherein each transformation in the set of transformations introduces a different two-dimensional skew modeling an orientation variation of an imaging surface.

18. The system of claim 16 wherein each transformation in the set of transformations introduces a random disparity modeling a depth variation of an imaging surface.

19. The system of claim 16 wherein the appearance transformer applies the set of transformations to a patch of the reference image including the projection feature.

20. The system of claim 16 wherein the prediction matcher compares the patch of the reference image to a number of patches of the image aligned along a same axis.
